(19) United States
(12) Patent Application Publication
(10) Pub. No.: US 2024/0132019 A1
(43) Pub. Date: Apr. 25, 2024

(54) VEHICULAR ENTRY SYSTEMS AND RELATED METHODS

(71) Applicant: Allyson McCollum, Corinth, TX (US)

(72) Inventor: Allyson McCollum, Corinth, TX (US)

(21) Appl. No.: 17/969,142

(22) Filed: Oct. 18, 2022

(51) Int. Cl. B60R 25/24

(52) U.S. Cl. CPC B60R 25/245; B60R 25/243; B60R 25/31

(57) ABSTRACT

Disclosed principles provide vehicular entry systems and methods comprising a sensing system disposed on each of the plurality of doors of the vehicle. Each sensing system detects a touch of a user at a corresponding door only when a presence detection system detects the presence of an authentication unit. Each sensing system causes a corresponding lock/unlock system to unlock a corresponding door of the vehicle, but not unlock any other doors, in response to the detecting of a touch of a user at the corresponding door and only with detection of the authentication unit. Additionally, each sensing system causes a corresponding lock/unlock system to automatically lock a corresponding door, but not lock any other doors, directly in response to a closing of the corresponding door previously unlocked by the corresponding lock/unlock system during the detecting of the authentication unit.

### TECHNICAL FIELD

The present disclosure relates to vehicle technology, and in particular to systems and methods related to unique vehicular keyless technology.

### BACKGROUND

A door handle for a vehicle door typically includes an activation portion or mechanism that when activated, causes an opening mechanism to release a latch and open the door. In older vehicles, the opening mechanism may be a cable or rod that operates the latch mechanism, while in newer vehicles, the opening mechanism is electronic in nature. In such systems, when a user operates the door handle, an electrical circuit may be used to activate the latch mechanism, for example, a relay and/or solenoid that activates the latch mechanism. Moreover, the door handles of newer vehicles often include a touch-detection system that detects when a user is touching the handle, and once touched, an electronic opening system then activates the latch mechanism. Conventional systems, even newer systems, which incorporate such a touch-detection system, operate only when the presence of some type of authentication unit or device is detected by the keyless entry system of the vehicle. Without such an authentication detection system, any person could simply touch the door handle of the vehicle and gain entry.

However, even the newest of such touch-detection entry systems suffer safety concerns. In particular, such conventional systems typically only unlock the driver's door or all of the doors of the vehicle. This opening of all the doors of vehicle may be dangerous. For example, unauthorized persons may gain entry to the vehicle if all of the doors are automatically unlocked when an authorized user simply touches a single handle. Similarly, if all of the vehicle doors are automatically unlocked when the vehicle stops and is placed in park, as is the case with most conventional systems, minors within the vehicle may open the door and exit the vehicle when it is not safe to do so. Similarly, even in systems where a user can manually unlock and open a passenger door individually, for example, to remove a child from the vehicle, the now-unlocked door may then become a safety concern again. In some cases, another minor intended to be left safely in the vehicle may now be capable of opening the now-unlocked door and exiting the vehicle when it is not safe to do so. In other cases, an unauthorized person may then gain entry into the vehicle through the now-unlocked door when the authorized user is not able to monitor the vehicle during their tending to the child they just removed from the vehicle.

Accordingly, what is needed is a keyless vehicle entry system that does not suffer from the deficiencies found in conventional systems discussed above. The disclosed principles provide such a vehicle entry system as well as other related keyless vehicle technology.

### SUMMARY

To overcome the deficiencies of the prior art, the disclosed principles provide vehicular entry systems and related methods of locking and unlocking doors of a vehicle. In one embodiment, a vehicular entry system in accordance with the disclosed principles comprises a presence detection system disposed in the vehicle and configured to detect the presence of an authentication unit proximate the vehicle. Exemplary presence detection systems can include a fob detection system or the detection of a mobile device, such a mobile telephone, or an application executing on a mobile device, of an authorized user of the vehicle. Such a vehicular entry system may also include a sensing system disposed on each of the plurality of doors of the vehicle. Each sensing system would be configured to detect a touch of a user at a corresponding door of the vehicle only when the presence detection system detects the presence of the authentication unit. Such a vehicular entry system may further include a lock/unlock system disposed on each of the plurality of doors of the vehicle.

In such embodiments, each of the sensing systems causes a corresponding lock/unlock system to unlock a corresponding door of the vehicle, but not unlock any other doors of the vehicle, in response to the detecting of a touch of a user at the corresponding door and only when the presence detection system detects the presence of the authentication unit proximate to the vehicle. Additionally, in such embodiments, each of the sensing systems causes a corresponding lock/unlock system to automatically lock a corresponding door of the vehicle, but not lock any other doors of the vehicle, directly in response to a closing of the corresponding door previously unlocked by the corresponding lock/unlock system during the detecting of the authentication unit proximate to the vehicle.

In another aspect, keyless vehicle technology in accordance with the disclosed principles provide a unique vehicular power window switch system. In one embodiment, such a vehicular power window system may comprise a plurality of power window switches, where each power window switch operates the opening and closing of a corresponding window of a vehicle. In addition, in such an embodiment, the power window switch system comprises an alternate mode wherein each of the power window switches operates the locking and unlocking of a corresponding door of the vehicle rather than the window of that corresponding door.

Numerous embodiments and advantages associated with each such embodiment are discussed in further detail below.

### BRIEF DESCRIPTION OF THE DRAWINGS

The detailed description that follows, by way of non-limiting examples of embodiments, makes reference to the noted drawings in which reference numerals represent the same parts throughout the several views of the drawings, and in which:

FIG. 1 illustrates a side view of a vehicle having a vehicular entry system installed thereon in accordance with one embodiment of the disclosed principles;

FIG. 2 illustrates a top view of a vehicle having a vehicular entry system installed thereon in accordance with another embodiment of the disclosed principles; and

FIG. 3 illustrates one embodiment of a power window switch system in accordance with the disclosed principles.

The above-referenced figures are provided herein for the purpose of illustration and description only and are not intended to define the limits of the disclosed principles.

### DETAILED DESCRIPTION

In view of the foregoing, through one or more various aspects, embodiments and/or specific features, the present disclosure is intended to bring out one or more of the advantages that will be evident from the description. The present disclosure makes reference to one or more specific embodiments by way of illustration and example. It is understood, therefore, that the terminology, examples, drawings and embodiments are illustrative and are not intended to limit the scope of the disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### Vehicular Entry System

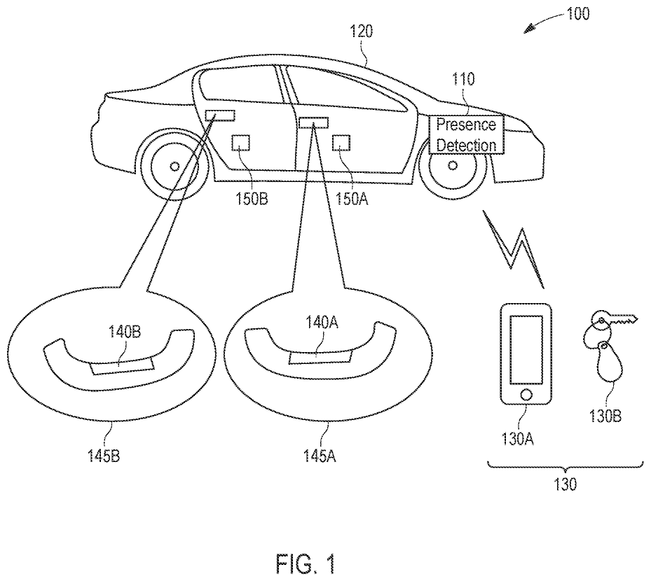

Looking initially at FIG. 1, illustrated is a vehicular entry system 100 disposed on an exemplary vehicle 120 in accordance with one embodiment of the disclosed principles. In this illustrated embodiment, the vehicular entry system 100 includes a presence detection system 110. The presence detection system 110 is disposed somewhere within the vehicle 120, and is typically part of the keyless entry system (not illustrated) provided with the vehicle 120. It should be noted that the presence detection system 110 may be comprised of more than one component, and may instead be comprised of a combination of multiple components, including hardware, software, one or more processors, firmware, memory and storage, and other related components.

The presence detection system 110 is configured to detect the presence of an authentication unit or device that is located proximate to the vehicle 120. For example, the authentication unit may be a mobile device 130A of a user or a software application executing on the mobile device of a user, or a fob 130B carried by a user. Such a fob 130B may be a dedicated fob, or may be a fob-based device included in another device carried by a user, such as a key to the vehicle 120. Multiple authentication units (collectively 130) may also be employed by any user. Moreover, the authentication unit(s) 130 may operate using any proximity-based technology, such as radio waves, Bluetooth communications, near-field communications (NFC), radio-frequency identification (RFID) communications, or any other active or passive wireless communication protocol for detection of the authentication unit 130 proximate to the vehicle 120. Once the authentication unit 130 is detected proximate to the vehicle 120, a sensing system in communication with the presence detection system 110 is activated. Communication between the sensing system and the presence detection system 110 may be via wired or wireless communications.

The sensing system 140A, 140B (collectively 140) may be disposed on or in each of a plurality of doors of the vehicle 120, or on or in a component of each door of the vehicle 120. In exemplary embodiments of the disclosed principles, a sensing system 140 is disposed in corresponding handles 145A, 145B of the vehicle 120. Each sensing system 140 is configured to detect a touch of a user at a corresponding door of the vehicle 120. Moreover, such detection of a touch of a user only occurs when the presence detection system 110 detects the presence of an authentication unit 130 proximate to the vehicle 120. In this sense, the sensing system 140 in a handle (collectively 145) functions similarly to conventional systems. Specifically, when the authentication unit 130 of a user, such as key or fob, is detected proximate to the vehicle 120, the user's touch of a sensing system 140 on a handle 145 of the vehicle 120 operates a lock/unlock system or unit of the vehicle 120.

Accordingly, the exemplary vehicular entry system 100 includes a lock/unlock system 150A, 150B (collectively 150) disposed on each of the plurality of doors of the vehicle 120. Each of the lock/unlock systems 150 may be comprised of any of a number of components, both mechanical and electrical. For example, a lock/unlock system 150 may be comprised of an electrical circuit connected with wiring to one or more components of the vehicle 120, such as one or more lock/unlock buttons as well as power to operate the lock/unlock system 150. In addition, each lock/unlock system 150 may include mechanical components such as linkages, solenoids and related components that work together to operate the lock or unlock feature of a corresponding door. As such, when activated, the lock/unlock system 150 on a particular door operates to lock or unlock that particular door. However, that is where the similarities between conventional operation and a sensing system 140 as disclosed herein ends.

The disclosed principles provide a vehicular entry system 100 that provides unique functionality to each of the lock/unlock systems 150 of the vehicle 120, separate and apart from one another. Specifically, in a vehicular entry system 100 as disclosed herein, each lock/unlock system 150 may be configured to unlock a corresponding door where a particular lock/unlock system 150 is located, but not unlock any other doors of the vehicle 120, in response to such detecting of a touch of a user at a corresponding door of the vehicle 120. This unlocking of just a corresponding door may be configured to occur only when the presence detection system 110 detects the presence of the authentication unit 130.

In conventional systems, when a user touches the driver side sensing system, which is typically in the handle of the driver's door, the driver's door unlocks. However, when a user, after their authentication unit has been detected proximate to the vehicle, touches a sensing system on any of the other doors/handles of the vehicle, all of the doors (or the remaining doors not including the driver's door) unlock. In contrast, with a vehicular entry system 100 as disclosed herein, when a user touches a sensing system 140 on a particular door, only the lock/unlock system 150 for that particular door unlocks that door.

Furthermore, each lock/unlock system 150 in each door of the vehicle 120 in a system as disclosed herein is further configured to automatically lock its corresponding door of the vehicle 120, but not lock any other doors of the vehicle 120, directly in response to a closing of a corresponding door previously unlocked by a corresponding lock/unlock system 150. Again, this automatic locking of just the corresponding door may be configured to occur during the detection of the authentication unit 130 proximate to the vehicle 120, and also does not affect the locking or unlocking of any of the other doors of the vehicle 120. In contrast to a system as disclosed herein, conventional systems are not configured to automatically lock just the one door, where a sensing system was used to unlock that door, in response to simply closing that door.

Additionally, a system in accordance with the disclosed principles may also be configured such that certain doors locking/unlocking certain doors of the vehicle may be programmable. More specifically, instead of only locking/unlocking the door on which the touched sensing system 140 is touched, a system as disclosed herein may be programmed to open one or more additional doors upon that detected touching. For example, if the handle 145B, and thus the corresponding sensing system 140B associated with that handle is touched, the system 100 may be programmed to not only unlock that corresponding door, but also the adjacent front passenger door on the same side of the vehicle. Or, alternatively or additionally, unlock the other back door of the vehicle such that passengers on both sides of the vehicle can exit (or be prevented from exiting in the case of the sensing system 140 locking one or more such doors). Also, a system 100 as disclosed herein may also be programmable to simply function in the same manner as a conventional system, as discussed above, when desired by a user.

Furthermore, the detecting system(s) 140 may be located in a position other than proximate to or physically on the corresponding doors of a vehicle. For example, a detecting system may be provided on a display panel of a vehicle, which may include one or more buttons that a user may touch or press. Additionally, the detecting system(s) 140 may be disposed in a fob or other similar type of key ring or key-based device associated with the vehicle. In such embodiments, instead of user touching a sensing system 140 on the handle (or other location) of the vehicle, the user may touch or otherwise operate one or more buttons on such a fob-type device. Still further, in some embodiments, the detecting system(s) may be provided in a software application. For example, a software application may be executing on a mobile device of the user, and which provides a user interface that the user can interact with to activate a detecting system associated with each of the vehicle's doors. In such embodiments, instead of a user touching a sensing system 140 on or near a handle of the vehicle, the user may instead touch an interactive button or similar feature on a user interface of a software application that causes the system 100 functionality as discussed above. Moreover, such a software application having a user interface is not limited to an application executing on user's mobile phone or similar device, and may instead be executed on any capable device associated with the user. Also, such software application interaction is not limited to requiring physical touch by the user, but instead may include user interaction in any other way, such as voice commands by the user. In fact, such non-touch user interaction may also be provided in a system as disclosed herein when the sensing system(s) is disposed in or on the vehicle.

The unlocking of a specific door of a vehicle 120 when the sensing system 140 corresponding to that door is touched by a user whose authentication unit 130 is detected proximate to the vehicle 120, and then the automatic locking of that same door when it is closed and when the sensing system 140 for that door was used to unlock it, provides unique safety features not available on current vehicles. As discussed above, in a situation when a user is removing a child from a passenger door of the vehicle, it is important that the door at that location not be unlocked until the user actually desires it and thus causes the sensing system 140 to do so. This prevents the child from prematurely opening the door and exiting the vehicle when it may not be safe to do so, or prevents an unauthorized person from trying to open the door. Similarly, the unlocking of that passenger door using the sensing system 140 corresponding to that door does not unlock any of the other doors of the vehicle 120. This further prevents the situation where another child may open a different, unlocked door and exit the vehicle when it is not safe to do so or when the user doesn't desire it. It also prevents the situation where an authorized person attempts to remove the child from the car by opening their door, or simply tries to gain unauthorized entry into the vehicle 120. Moreover, by automatically locking the door just opened by the user using the sensing system 140 corresponding to that door, the user can turn their attention away from the vehicle 120 and instead maintain watch of the child they just removed from that door, without the risk that another child still within the vehicle 120 exits the vehicle when it is not safe to do so or is simply undesirable by the user. Similarly, this automatic locking of that door also prevents an authorized person from opening that door in an attempt to gain entry into the vehicle 120.

Other advantages are also provided by a system in accordance with the disclosed principles. For example, in situations where a user is loading or unloading items into or out of the vehicle 120, the user does not need to continuously unlock and relock the vehicle as they move back and forth moving such items. Specifically, a user might unload bulky items from one of the doors of the vehicle 120 and does not want to stop and put the items down so that they can lock the door do that they can carry the items to a location where watching the vehicle may not be an option. With a system as disclosed herein, once the user unlocks the door where they will be removing items with a disclosed sensing system 140, they can simply push the door closed once they are carrying the items and the door will automatically lock once it closes. Importantly, when the user touched the sensing system 140 on the door to unlock and open it, no other doors were unlocked, thus keep those entries into the vehicle secure. Similarly, when the door closed and automatically relocked, no other locks on other doors were affected, hence leaving all doors of the vehicle 120 locked and secure without additional action by the user. The same is true for situations where a user is loading items into the vehicle. Once the user places the items in the car the door can simply be closed, and it will automatically lock so that the user does not need to remember or take the time to lock the vehicle 120 each time that place something in the vehicle 120.

Variations in a vehicular entry system in accordance with the disclosed principles are also possible in advantageous embodiments. For example, the automatic locking of a door of the vehicle 120 in response to a closing of the door, when it was unlocked with a corresponding sensing system 140, may include a delay for a preset period of time before the automatic locking takes place. In such embodiments, by delaying the automatic locking for, for example, 3 seconds, the user can elect to reopen the door within that period of time within having to activate the sensing system 140 of that door to unlock the door again. Of course, any amount of delay time may be employed from seconds to even minutes or longer, depending on the situation the user faces.

In some embodiments, the detecting of a touch of a user by a sensing system as disclosed herein may comprise something more than simply detecting a mere touch of a user. For example, the detecting may comprise detecting a touching gesture of the user, or some other unique manner of touching by the user. Such a gesture could includes touching the sensing system 140 with a certain number of fingers, swiping the sensing system 140 with a predetermined motion and/or with a predetermined number of fingers, or making a predetermined motion with one or more fingers. Also, the touching gesture of the user may simply be a specific type of touch lasting a predetermined period of time. Of course, other types of touching gestures may also be performed and detected by a sensing system 140 as disclosed herein. Still further, the sensing system(s) 140 may be located in other places on the vehicle door besides the handle 145. For example, a sensing system 140 may be located on the exterior of the door proximate to the handle 145, on a specific area of the door away from the handle 145, or could be located on a different area of the handle 145 aside from the interior portion of the handle 145 grasped by a user.

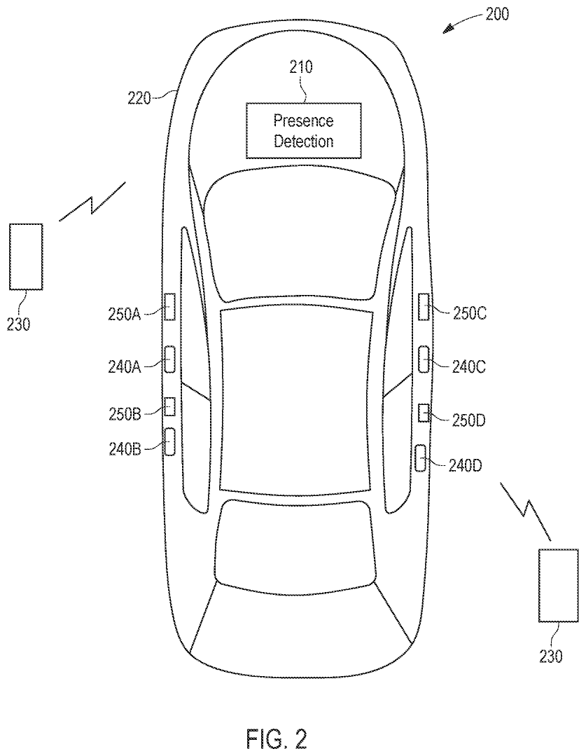

Turning now to FIG. 2, illustrated is a top view of a vehicle 220 having a vehicular entry system 200 installed thereon in accordance with another embodiment of the disclosed principles. In this embodiment, a presence detection system 210 is again included in the vehicle 220. As before, the presence detection system 210 may be included as part of the vehicle's keyless entry system, or may be a distinct system in communication with the keyless entry system. As such, the keyless entry system may be employed with the presence detection system 210 to provide the detection of an authentication unit 230 disclosed herein, or the presence detection system 210 may solely provide such presence detection of an authentication unit 230.

As illustrated, in this embodiment the vehicular entry system 200 includes four sensing systems 240A, 240B, 240C, 240D (collectively 240), each one corresponding to a door of the vehicle 220. Each of these sensing systems 240 may be comprises as disclosed above, and may function in any of the manners as disclosed herein. Furthermore, the sensing systems 240 may be disposed on the handles of the corresponding doors of the vehicle 220 as discussed above, or may be disposed in any other location where they may be in communication with corresponding lock/unlock systems 250A, 250B, 250C, 250D (collectively 250) to perform in accordance with the disclosed principles. As with the system disclosed above, each sensing system 240 is again configured to detect a touch of a user at a corresponding door of the vehicle 220. Such detecting may also be in the form of any type of contact by the user, whether that contact be a prolonged touch or some type of specialized touch such as a gesture or other contact as described above. Moreover, such detection of a touch of a user only occurs when the presence detection system 210 detects the presence of a user's authentication unit 230 proximate to the vehicle 220.

As before, with the illustrated vehicular entry system 200, each lock/unlock system 250 may be configured to unlock a corresponding door where a particular lock/unlock system 250 is located, but not unlock any other doors of the vehicle 220, in response to the detecting of a touch of a user at a corresponding door of the vehicle 220. Again, this unlocking of just a corresponding door occurs only when the presence detection system 210 detects the presence of the authentication unit 230. Each lock/unlock system 250 in each door of the vehicle 220 is again configured to automatically lock its corresponding door of the vehicle 220, but not lock any other doors of the vehicle 220, in response to a closing of the door previously unlocked by the lock/unlock system 250. This embodiment of the vehicular entry system 200 can also provide the same safety features not available with conventional keyless entry systems, as detailed herein.

### Vehicular Power Window Switch System

In addition to vehicular entry systems and related methods as disclosed herein, the disclosed principles further provide for a unique vehicular power window switch system. In one aspect, such a vehicular power window switch system includes a plurality of power window switches wherein each power window switch operates the opening and closing of a corresponding window of the vehicle. Additionally, however, in a vehicular power window system as disclosed herein, the system includes an alternate mode wherein each of the power window switches also operates the locking and unlocking of a corresponding door of the vehicle. In order for each power window switch to provide operation of the locking mechanism, a system as disclosed herein provides the alternate mode for each of the power window switches in any of a number of manners.

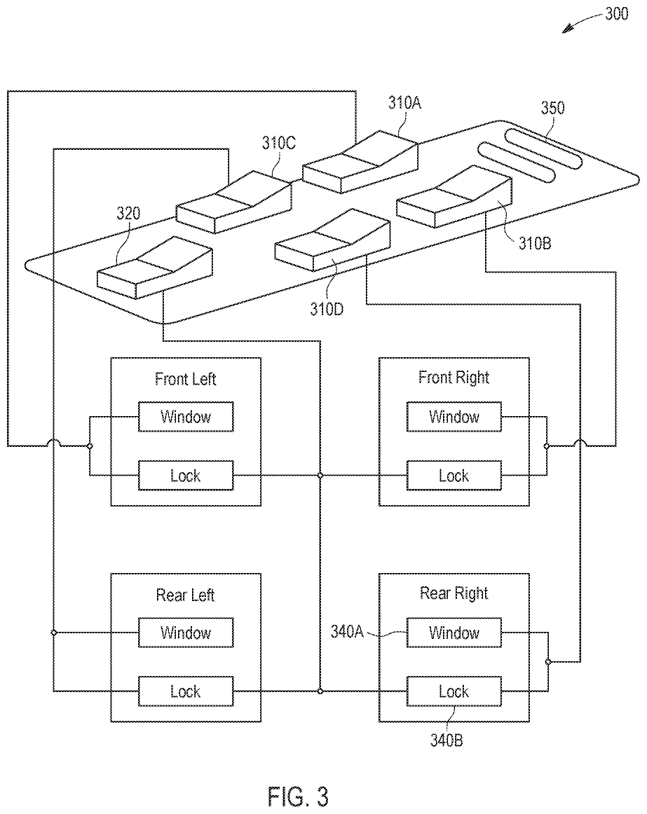

In some embodiments, the alternate mode is provided by a mode switch of the power window switch system. Looking at FIG. 3, illustrated is a one embodiment of a power window switch system 300 in accordance with the disclosed principles. In this embodiment, the illustrated system 300 includes a plurality of power window switches (310A, 310B, 310C, 30110D; collectively, 310). As in conventional power window systems, the illustrated power window switches 310 each operate the opening and closing of a corresponding window of the vehicle in which the system 300 is installed. Illustrated near the power window switch system 300 is a door lock/unlock switch 320, which is configured to collectively lock or unlock the doors of the vehicle when operated in the appropriate manner.

Also illustrated is a dedicated alternate mode switch 330 that may be located proximate to the power window switches 310. In accordance with the disclosed principles, activation of the alternate mode switch 330 changes the operation of the power window switches 310 from individually operating windows of the vehicles corresponding to each of the power window switches 310, to individually operating the door locks on corresponding doors of the vehicles. For example, the right rear power window switch 310D typically operates the window mechanism 340A to open and close the window of the right rear door when the power window switch system 300 is in the standard mode. However, when switched to the alternate mode, the right rear power window switch 310D will instead operate the power lock mechanism 340B of the right rear door to lock or unlock that door. This permits the unique locking and unlocking of individual doors of the vehicle, rather than the locking or unlocking of all doors of the vehicle at one time as is found conventional power lock systems.

As with the vehicle entry systems disclosed herein, there may be significant safety concerns with simply unlocking all of the doors of a vehicle at one time with the door lock/unlock switch 320. These concerns may include the risk of entry into the vehicle by an unauthorized person when all of the vehicle doors unlock together. Another concern may be the exiting of the vehicle by a child or other person when it is not safe to do so, or simply when the driver of the vehicle does not desire it. Instead, a power window switch system 300 in accordance with the disclosed principles provides an authorized operator of the vehicle to selectively unlock (or lock) individual doors of the vehicle. Advantageously, rather than requiring additional power lock switches 320 be installed in the vehicle, the alternate mode of a switch system 300 as disclosed herein can employ the same power window operation switches 310 to provide the individual unlocking and locking of the vehicles doors.

Activating the alternate mode of a power window switch system 300 as disclosed herein may be accomplished in any of a number of ways. For example, as mentioned above, a dedicated alternate mode switch 350 may be provided, similar to the “window lock” switch 360 that is typically present in modern vehicles with power windows, and which prevents other occupants in the vehicle from operating their window through the window switch at their location. In some embodiments, the alternate mode switch may be the window lock switch 360 itself, for example, if that switch 360 is pressed more than once (e.g., double clicked) or is held for a predetermined period of time.

In some embodiments, the widow lock switch 360 may be on a timer where the switch remains in the alternate mode for only a predetermined period of time, whereafter, the switch 360 exits the alternate mode and returns to its normal operational mode. Alternatively, a window lock switch may actually be divided into two switches blended together, one for operating the window lock and one for activating the alternate mode. For example, the two blended switches may be provided as a rocker switch, where tilting the switch one direction activates the normal window lock functions and tilting it the other way activates the alternate mode. Or two distinct switches may similarly be provided that are shaped to look like a single switch for aesthetic purposes.

In other embodiments, the alternate mode may be entered using a fob or other device configured to work with the key of the vehicle, which may even include a button to activate the alternate mode. In yet other embodiments, the alternate mode may be entered using a setting of the vehicle, for example, accessible through the dashboard display unit, or the mode may be entered using an application executing on a mobile device of the user. In sum, the disclosed principles encompass any manner for activating an alternate mode for the power window switches in accordance with the disclosed principles.

In yet other embodiments, the alternate mode of a power window switch may be provided in each of the power window switches 310 themselves. For example, in many modern vehicles, one or more of the power window switches has an “express” function, whereby when the switch 310 is activated and held for a predetermined period of time and then released, the window operated by that switch 310 is lowered or raised in its entirety without the user needing to hold the switch 310. Similarly, the disclosed principles may provide power window switches 310 whose operation in a particular manner activates the alternate mode described herein. For example, rather than holding the switch 310 for a certain amount of time to activate such an “express mode”, a switch 310 as disclosed herein may be clicked twice quickly (i.e., double-clicked) to activate the alternate mode operation of that switch 310. In such an embodiment, the two quick clicks of the window switch 310 may cause the door corresponding to that switch 310 to lock or unlock, rather than operate the corresponding window, without any additional action by the user. In other embodiments, instead of two clicks of a window operating switch 310, the disclosed alternate mode may be activated by three clicks, or perhaps by simply holding the window switch 310 down for several seconds, more than the hold that is needed for activating express open or express closed of the corresponding window.

The foregoing description has made reference to several exemplary embodiments. It is understood, however, that the words that have been used are for description and illustration, rather than words of limitation. Thus, the present embodiments are therefore to be considered in all respects as illustrative and not restrictive. Changes may be made within the purview of the appended claims, as presently stated, and as amended, without departing from the scope and spirit of the disclosure in all its aspects. All changes which come within the meaning and range of equivalency of the claims are therefore intended to be embraced therein. Although this description makes reference to particular means, materials and embodiments, the disclosure is not intended to be limited to the particulars disclosed; rather, the disclosure extends to all functionally equivalent technologies, structures, methods and uses such as are within the scope of the appended claims. Further, the recitation of any method steps does not denote a particular sequence for execution of the steps. Such method steps may therefore be performed in a sequence other than recited unless the particular claim expressly states otherwise.

In the numerous embodiments of the inventive subject matter disclosed herein, such embodiments may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus, the following claims are hereby incorporated into the Detailed Description, with each claim standing on its own as a separate embodiment.

1. A vehicular entry system, comprising:
a presence detection system disposed in the vehicle and configured to detect a presence of an authentication unit proximate said vehicle;
a sensing system disposed on each of a plurality of doors of the vehicle, each sensing system configured to detect a touch of a user at a corresponding door of the vehicle only when said presence detection system detects said presence of said authentication unit;
a lock/unlock system disposed on each of the plurality of doors of the vehicle, each lock/unlock system configured to lock and unlock a corresponding door of the vehicle;
wherein each of said sensing systems causes a corresponding lock/unlock system to unlock a corresponding door, but not unlock any other doors of the vehicle, in response to said detecting of a touch of a user at the corresponding door and only when said presence detection system detects said presence of said authentication unit; and
wherein each of said sensing systems causes a corresponding lock/unlock system to automatically lock a corresponding door, but not lock any other doors of the vehicle, directly in response to a closing of the corresponding door previously unlocked by the corresponding sensing system and lock/unlock system during said detecting of said authentication unit proximate said vehicle.

2. A vehicular entry system according to claim 1, wherein the authentication unit is a fob.

3. A vehicular entry system according to claim 1, wherein the authentication unit is a mobile device of a user of the vehicle.

4. A vehicular entry system according to claim 1, wherein the authentication unit is an application executing on a mobile device of a user of the vehicle.

5. A vehicular entry system according to claim 1, wherein each said sensing system is disposed in a handle of a corresponding door.

6. A vehicular entry system according to claim 1, wherein said automatic locking of a corresponding door of the vehicle in response to a closing of a corresponding door of the vehicle further comprises delaying said automatic locking for a preset period of time.

7. A vehicular entry system according to claim 1, wherein said detecting a touch of a user at a corresponding door further comprises detecting a touching gesture of the user.

8. A vehicular entry system according to claim 7, wherein the touching gesture of the user comprises a touching lasting a predetermined period of time.

9. A method of locking and unlocking doors of a vehicle, said method comprising:
detecting a presence of an authentication unit proximate said vehicle;
detecting a touch of a user at a door of the vehicle, using a corresponding sensing system disposed in said door of said vehicle, only when said presence of said authentication unit is detected;
causing, with a sensing system, a corresponding lock/unlock system of a corresponding door to unlock said corresponding door, but not unlock any other doors of the vehicle, in response to said detecting of a touch of a user at the corresponding door and only when said presence of said authentication unit is detected; and
causing, with a sensing system, a corresponding lock/unlock system to automatically lock said corresponding door, but not lock any other doors of the vehicle, directly in response to a closing of the corresponding door previously unlocked by the corresponding sensing system and lock/unlock system during said detecting of said authentication unit proximate said vehicle.

10. A method according to claim 9, further comprising disposing each said sensing system in a handle of a corresponding door of the vehicle.

11. A method according to claim 9, wherein said automatic locking of a corresponding door of the vehicle in response to a closing of the corresponding door of the vehicle further comprises delaying said automatic locking for a preset period of time.

12. A method according to claim 9, wherein said detecting a touch of a user at a corresponding door further comprises detecting a touching gesture of the user.

13. A vehicular entry system according to claim 12, wherein the touching gesture of the user comprises a touching lasting a predetermined period of time.

14. A vehicular power window switch system, comprising:
a plurality of power window switches wherein each switch operates the opening and closing of a corresponding window of the vehicle;
wherein said switch system comprises an alternate mode wherein each of the power window switches operates the locking and unlocking of a corresponding door of the vehicle.

15. A vehicular power window switch system according to claim 14, wherein said vehicular power window switch system comprises an alternate mode switch configured to activate said alternate mode.

16. A vehicular power window switch system according to claim 15, wherein said alternate mode switch is comprised in a setting of the vehicle.

17. A vehicular power window switch system according to claim 14, wherein said vehicular power window switch system comprises a window lock switch configured to prevent remote operation of the corresponding windows, wherein said window lock switch is further configured to activate said alternate mode.

18. A vehicular power window switch system according to claim 17, wherein said window lock switch is configured to activate said alternate mode when said window lock switch is double-clicked.

19. A vehicular power window switch system according to claim 17, wherein said window lock switch is configured to activate said alternate mode when said window lock switch is pressed for a predetermined period of time.

20. A vehicular power window switch system according to claim 14, wherein each of said power window switches is further configured to activate said alternate mode when any of said power window switches is doubled-clicked, wherein a double-click of a power window switch operates the locking and unlocking of a corresponding door of the vehicle.
